(19) United States
(12) Patent Application Publication
(10) Pub. No.: US 2020/0156234 A1
(43) Pub. Date: May 21, 2020

(54) Side Handle of Angle Grinder

(71) Applicant: Valeriy I. SPRYGIN, Moscow (RU)

(72) Inventor: Valeriy I. SPRYGIN, Moscow (RU)

(21) Appl. No.: 16/533,049

(22) Filed: Aug. 6, 2019

(30) Foreign Application Priority Data
Nov. 15, 2018 (RU) 2018140267

(51) Int. Cl. B25F 5/02; B24B 23/02

(52) U.S. Cl. CPC B25F 5/027; B24B 23/028

(57) ABSTRACT

The utility model relates to utilities (accessories) for hand electrical instrument, in particular, to the auxiliary handles for hand grinders intended for cutting, grinding and finishing articles made of different materials. The side handle of angle grinder includes a gripping part, a guard and a fitting (plug), wherein a gripping part contains a cavity for placing of marking tools, which cavity has the internal thread on an inlet, characterizing in that common body of handle is made from polymer, and internal thread for fixation of marking tools is provided on metal insert fixed in the vicinity of the inlet to the cavity. The technical result is to provide the reliability of easily-portable attachment of accessories provided by making thread on metal insert.

### RELATED APPLICATIONS

This application claims priority to Russian Patent Application RU 2018140267, filed Nov. 15, 2018, which is incorporated herein by reference in its entirety.

### FIELD OF THE INVENTION

This utility model relates to utilities (accessories) for hand electrical instrument, in particular, to the auxiliary handles for hand grinders intended for cutting, grinding and finishing articles made of different materials.

### BACKGROUND OF THE INVENTION

Usually some auxiliary instruments are required for processes dealt with use of angle grinder: punches, marking tools (marking tools are hand instruments for making ticks and lines on marked surface using a ruler, square ruler or pattern, i.e. steel marking pen, preferably, hard alloyed pen) etc. Use of angle grinder supplemented with the said instruments will have an influence to the professional mobility of an operator and, finally, to increasing of productivity.

Known is a angle grinder (patent RU 2434731 of 27 Nov. 2011), having a housing with motor mounted therein, attached to a spindle where processing means are mounted, for example, grinding wheel or drilling tool. Side handle in this patent is numbered with position 4.

A drawback of the present hand grinder is that its side handle does not have any construction features allowing to provide storage of marking (drawing) or auxiliary instruments.

### SUMMARY OF THE INVENTION

A technical object of this utility model is to diversify possibilities of handle of angle grinder with simultaneous securing of reliability (useful life) of instrument with easily-portable attachment of accessories.

The technical aim is achieved by that the side handle of angle grinder includes a gripping part, a guard and a fitting (plug), wherein a gripping part contains a cavity for placing of marking tools, which cavity has the internal thread on an inlet, characterizing in that common body of handle is made from polymer, and internal thread for fixation of marking tools is provided on metal insert fixed in the vicinity of the inlet to the cavity.

This decision provides reliability (in particular, durability of useful life) of easily-portable attachment of accessories, as an insert has been made from more hard material than handle.

As the cavity is made with threaded insert, the marking tools located in the cylindrical cavity of angle grinder shall have a corresponding complementary thread provided in the base of the marking tools.

In a particular embodiment the cavity can be provided either on the center of the handle, or with displacement to the edge of the handle.

In a particular embodiment a fitting (plug) of handle may be made smooth or with some thread, slot, grip or it may have other construction for fixation on the body of angle grinder.

### BRIEF DESCRIPTION OF THE DRAWINGS

Utility model is disclosed on the following drawings.

FIG. 1 (a perspective view) provides a particular exemplary embodiment, wherein a handle of angle grinder includes gripping part 1, guard 2 and fitting (plug) 3, and a gripping part contains the cavity 4 for placing the marking tools 5, wherein the cavity 4 has been displaced to the edge of the handle, and the threaded insert 6 is placed on the inlet into cavity.

FIG. 2 (a perspective view) provides a particular exemplary embodiment, wherein a handle of angle grinder includes the gripping part 1, the guard 2 and the fitting (plug) 3, and the gripping part contains the cavity 4 for placing of the marking tools 5, wherein the cavity 4 has been provided on the centre of axis of the handle, and the threaded insert 6 is placed on the inlet into the cavity.

FIG. 3 (side view) provides a particular exemplary embodiment, wherein the handle of angle grinder includes the gripping part 1, the guard 2 and the fitting (plug) 3, and the gripping part contains the cavity 4 for placing of the marking tools 5, wherein the cavity 4 has been provided on the center of axis of the handle, and the threaded insert 6 is placed on the inlet into the cavity.

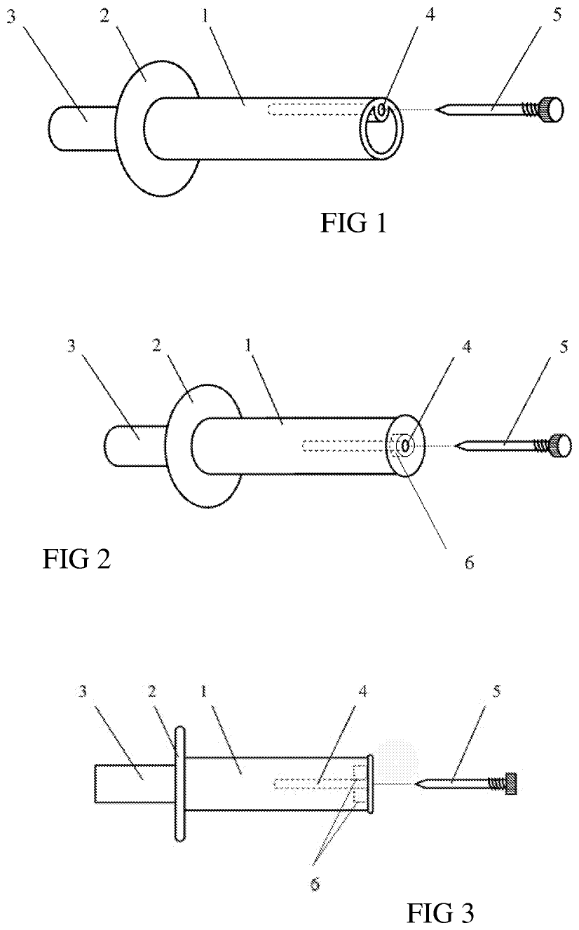

### DETAILED DESCRIPTION OF THE PREFERRED EMBODIMENTS

Use of Utility Model

The marking tools (marking pen) is a metal stem, one end (working part) of which is tooled as a cone; it is used for marking a cutting line on ceramic tile, ceramic granite tile and other solid surfaces. Upon realization of provided technical decision an operator which proceeds with marking operations has a possibility to fix the marking tools inside of side (replacement) handle of instrument (of angle grinder). When it is necessary to use the fixed marking instrument, it is handled by hand on projected part (backplate) and taken off (turned over) from cylindrical cavity located in the handle. Reliability and stability of handle and fixation of marking instruments has been provided by metallic insert with thread.

1. A side handle of an angle grinder, the side handle comprising:
a gripping part, a guard and a fitting,
wherein the gripping part comprises:
a body made of polymer having an end facing a direction of inserting a threaded marking tool;
a cavity for inserting the threaded marking tool, the cavity having an inlet opening facing the direction of inserting the marking tool; and
a metal insert fixedly attached to the body at the end facing the direction of inserting the marking tool and forming the inlet opening of the cavity,
wherein the metal insert has an internal thread providing a threaded joint with inserted threaded marking tool.

2. The side handle according to claim 1, wherein the cavity is disposed along a central axis of the side handle.

3. The side handle according to claim 1, wherein the cavity is displaced relative the central axis of the handle towards a periphery of the handle.
